(19) United States
(12) Patent Application Publication
(10) Pub. No.: US 2015/0132974 A1
(43) Pub. Date: May 14, 2015

(54) ADAPTER FOR USING TWO ONE-WAY LIGHT BULBS IN A THREE-WAY LIGHT SOCKET

(71) Applicant: DAVID W. KAPELLA, RICHMOND, VA (US)

(72) Inventor: DAVID W. KAPELLA, RICHMOND, VA (US)

(21) Appl. No.: 14/079,614

(22) Filed: Nov. 13, 2013

(51) Int. Cl. H01R 27/02; H01R 35/02; H01R 35/04

(52) U.S. Cl. CPC H01R 27/02; H01R 35/04; H01R 35/02
USPC 439/8; 439/639; 439/9

(57) ABSTRACT

An adapter for using two one-way light bulbs in a three-way light socket comprises a lower body, a first female socket body, and a second female socket body. The lower body comprises a male metal threaded base for screwing into a three-way light socket. The first female socket body is connected to the lower body and comprises a first female threaded socket for receiving a first one-way light bulb. The second female socket body is connected to the lower body and comprises a second female threaded socket for receiving a second one-way light bulb. The first one-way light bulb is energized when the three-way light socket switch is in a low position, the second one-way light bulb is energized when the three-way light socket switch is in a medium position, and both one-way light bulbs are energized when the three-way light socket switch is in a high position.

### FIELD OF THE INVENTION

The present invention relates generally to lighting, and more specifically to light bulb splitters.

### BACKGROUND

Three-way light sockets (such as in a lamp) are designed to receive a three-way light bulb. A three-way incandescent light bulb has two different filaments, each having a different wattage and producing a different amount of light. A three-way light socket has four switch positions: off, low, medium, and high. In the off position, neither filament is energized. In the low position, the lower wattage filament is energized. In the medium position, the higher wattage filament is energized. In the high position, both filaments are energized.

Three-way incandescent light bulbs have been relatively inexpensive and reliable. However, incandescent light bulbs are being phased out. Three-way compact fluorescent light bulbs (CFLs) are relatively expensive and unreliable. As such, a better solution is desired for using CFLs in three-way light sockets.

### BRIEF SUMMARY

In one embodiment of the invention, an adapter for using two one-way light bulbs in a three-way light socket comprises a lower body, a first female socket body, a second female socket body, first and second hot electrical connections, and first and second neutral electrical connections. The lower body comprises (a) a male metal threaded base for screwing into a three-way light socket, (b) a first hot contact for contacting a corresponding first hot contact in the three-way light socket when the male metal threaded base is screwed into the three-way light socket, and (c) a second hot contact for contacting a corresponding second hot contact in the three-way light socket when the male metal threaded base is screwed into the three-way light socket, the male metal threaded base, the first hot contact of the lower body, and the second hot contact of the lower body being electrically insulated from each other. The first female socket body is connected to the lower body and comprises (a) a first female threaded socket for receiving a first one-way light bulb, and (b) a hot contact for contacting a corresponding hot contact in the first one-way light bulb when the first one-way light bulb is screwed into the first female threaded socket, the first female threaded socket and the hot contact of first female socket body being electrically insulated from each other. The second female socket body is connected to the lower body and comprises (a) a second female threaded socket for receiving a second one-way light bulb, and (b) a hot contact for contacting a corresponding hot contact in the second one-way light bulb when the second one-way light bulb is screwed into the second female threaded socket, the second female threaded socket and the hot contact of second female socket body being electrically insulated from each other. The first hot electrical connection is between the first hot contact of the lower body and the hot contact of the first female socket body. The second hot electrical connection is between the second hot contact of the lower body and the hot contact of the second female socket body. The first neutral electrical connection is between the male metal threaded base and either the first female threaded socket or a neutral contact adjacent the first female threaded socket. The second neutral electrical connection is between the male metal threaded base and either the second female threaded socket or a neutral contact adjacent the second female threaded socket. The hot contact of the first female socket body is adapted to energize the first one-way light bulb when the first one-way light bulb is screwed into the first female threaded socket and when the first hot contact of the lower body is energized. The hot contact of the second female socket body is adapted to energize the second one-way light bulb when the second one-way light bulb is screwed into the second female threaded socket and when the second hot contact of the lower body is energized. The first and second female socket bodies are positioned and/or angled such that the first and second one-way light bulbs do not contact each other when the first one-way light bulb is screwed into the first female threaded socket and when the second one-way light bulb is screwed into the second female threaded socket.

The first and second female socket bodies may project upward from the lower body and outward at an angle to a longitudinal axis of the lower body.

The first and second female socket bodies may project outward from the lower body perpendicularly to a longitudinal axis of the lower body.

The first female socket body may project upward from the lower body parallel to a longitudinal axis of the lower body and the second female socket body may project outward from the lower body perpendicularly to the longitudinal axis of the lower body.

The first and second female socket bodies may project downward from an upper portion of the lower body and outward at an angle to a longitudinal axis of the lower body.

The first and second female socket bodies may be connected to the lower body via, respectively, first and second flexible arms.

The first and second female socket bodies may be connected to the lower body via, respectively, first and second ball-and-socket joints.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is a side view of an adapter for using two one-way light bulbs in a three-way light socket, in accordance with embodiments of the invention.

FIG. 2 is a bottom view of the adapter of FIG. 1

FIG. 3 is a sectional view of the adapter of FIG. 1

FIG. 4 is a side view of an adapter for using two one-way light bulbs in a three-way light socket, in accordance with alternative embodiments of the invention.

FIG. 5 is a side view of an adapter for using two one-way light bulbs in a three-way light socket, in accordance with alternative embodiments of the invention.

FIG. 6 is a side view of an adapter for using two one-way light bulbs in a three-way light socket, in accordance with alternative embodiments of the invention.

FIG. 7 is a side view of an adapter for using two one-way light bulbs in a three-way light socket, in accordance with alternative embodiments of the invention.

FIG. 8 is a side view of an adapter for using two one-way light bulbs in a three-way light socket, in accordance with alternative embodiments of the invention.

### DETAILED DESCRIPTION

Embodiments of the invention provide an adapter for using two one-way light bulbs in a three-way light socket. The first one-way light bulb (typically, although not necessarily a CFL) is energized when the three-way light socket switch is in a low position, the second one-way light bulb (typically, although not necessarily a CFL) is energized when the three-way light socket switch is in a medium position, and both one-way light bulbs are energized when the three-way light socket switch is in a high position. Typically, the first one-way CFL will have a different wattage and/or lumen output than the second one-way CFL. For example, a CFL with a 450 lumen output may be the first one-way light bulb and a CFL with an 800 lumen output may be the second one-way light bulb. Thus, 450 lumens of light is provided when the three-way light socket switch is in a low position, 800 lumens of light is provided, when the three-way light socket switch is in a medium position, and 1250 lumens of light is provided both one-way light bulbs are energized when the three-way light socket switch is in a high position. As such, adapters of embodiments of the invention provide the functionality of three-way light output while using less expensive and more reliable one-way light bulbs. Although embodiments of the invention are described herein in which the first and second one-way light bulbs are CFLs, embodiments of the invention will work with any suitable one-way light bulbs, including but not limited to incandescent, CFL, light emitting diode (LED), or halogen. Embodiments of the invention may have any suitable size/style of female socket to accept one-way light bulbs with the corresponding male base.

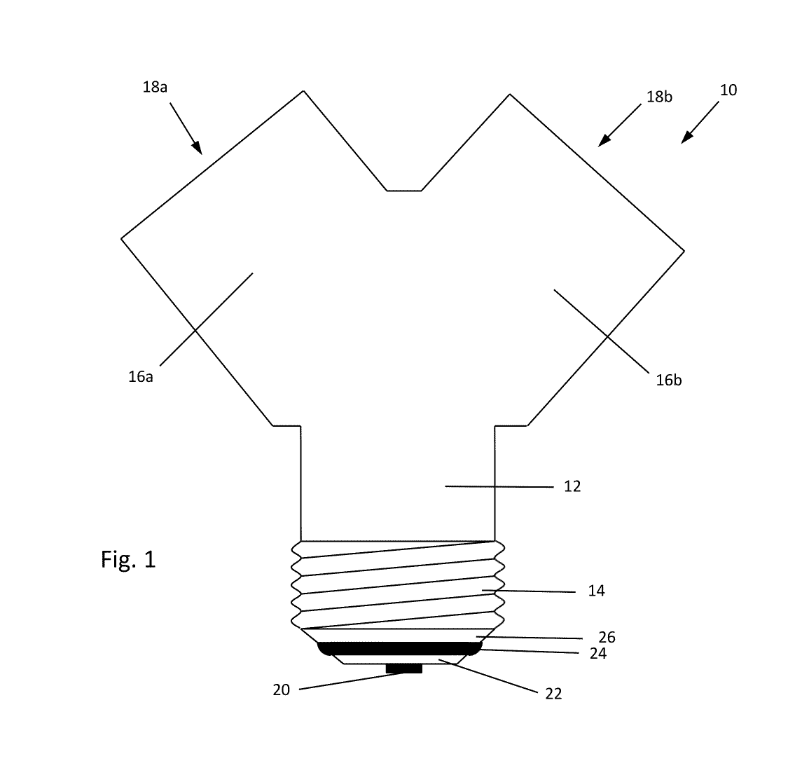

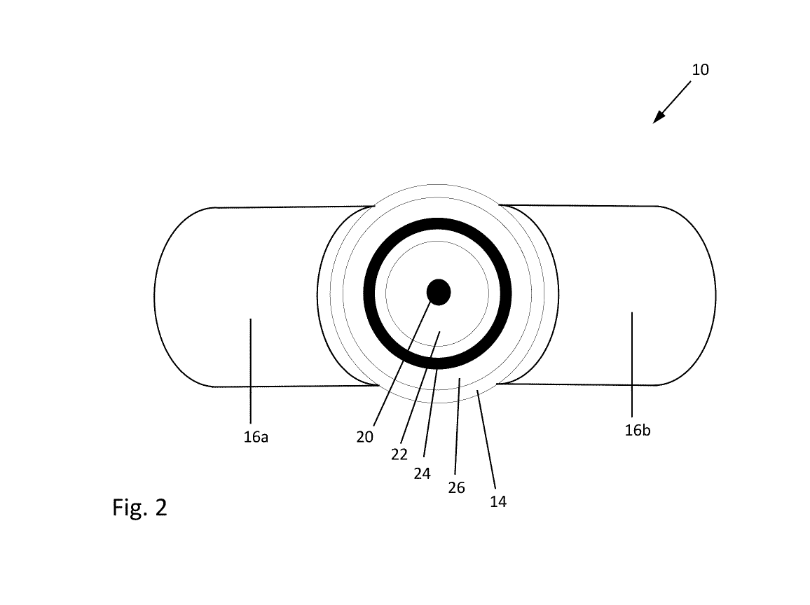

Referring now to FIGS. 1-3, an adapter for using two one-way light bulbs in a three-way light socket is illustrated in accordance with embodiments of the invention. Adapter 10 comprises a lower body 12, a first female socket body 16a, and a second female socket body 16b. An opening 18a is defined in the distal end of the first female socket body 16a for receiving a male threaded base of a first one-way CFL (not illustrated). An opening 18b is defined in the distal end of the second female socket body 16b for receiving a male threaded base of a second one-way CFL (not illustrated).

The lower body 12 comprises a male metal threaded base 14 for screwing into a three-way light socket, a first hot contact 20 for contacting a corresponding first hot contact (not illustrated) in the three-way light socket (not illustrated) when the male metal threaded base 14 is screwed into the three-way light socket, and a second hot contact 24 for contacting a corresponding second hot contact (not illustrated) in the three-way light socket (not illustrated) when the male metal threaded base 14 is screwed into the three-way light socket. One or more electrical insulators may be provided for electrically insulating the male metal threaded base, the first hot contact of the lower body, and the second hot contact of the lower body from each other. In the illustrated embodiment, a first electrical insulator 22 electrically insulates the first hot contact 20 and the second hot contact 24 from each other, and a second electrical insulator 26 electrically insulates the second hot contact 24 and the male metal threaded base 14 from each other. Typically, the lower body will be constructed of an electrically insulating material, such as plastic. Where the lower body is constructed of an electrically insulating material, a simple gap between the first hot contact, the second hot contact, and the metal base will provide the necessary electrical insulation.

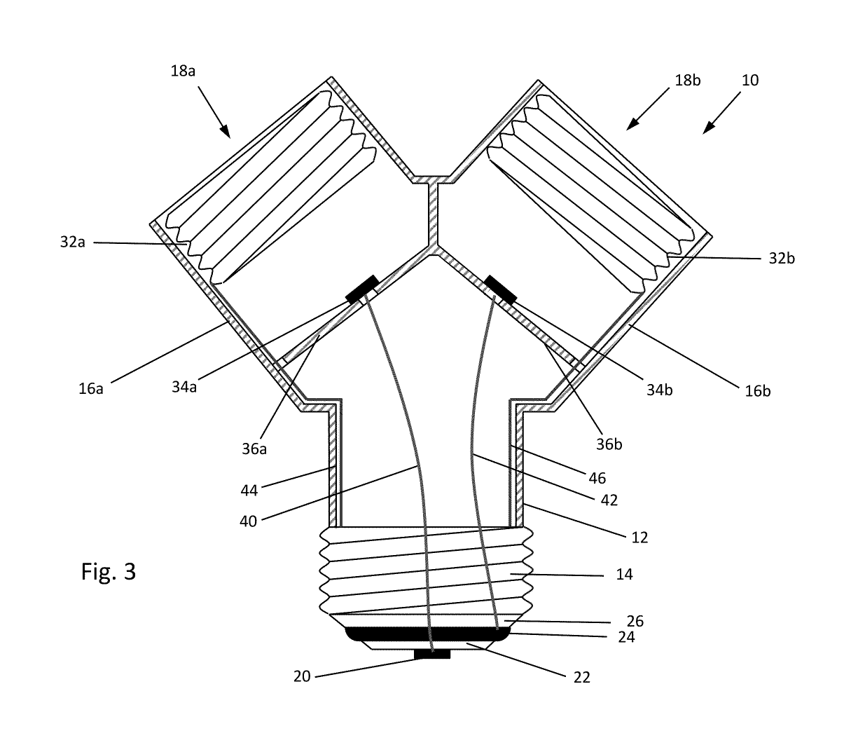

As seen in FIG. 1 and particularly in FIG. 3, the first female socket body 16a is connected to the lower body 12 and comprises a first female threaded socket 32a for receiving a first one-way light bulb (not illustrated), a hot contact 34a for contacting a corresponding hot contact (not illustrated) in the first one-way light bulb when the first one-way light bulb is screwed into the first female threaded socket 32a, and one or more electrical insulators 36a for electrically insulating the first female threaded socket 32a and the hot contact 34a of first female socket body 16a from each other. The second female socket body 16b is connected to the lower body 12 and comprises a second female threaded socket 32b for receiving a second one-way light bulb (not illustrated), a hot contact 34b for contacting a corresponding hot contact (not illustrated) in the second one-way light bulb when the second one-way light bulb is screwed into the second female threaded socket 32b, and one or more electrical insulators 36b for electrically insulating the second female threaded socket 32b and the hot contact 34b of second female socket body 16b from each other. Typically, the first and second female socket bodies will be constructed of an electrically insulating material, such as plastic. Where the first and second female socket bodies are constructed of an electrically insulating material, a simple gap between the hot contact and the female threaded socket of each female socket body will provide the necessary electrical insulation.

The adapter 10 further comprises a first hot electrical connection 42 between the first hot contact 20 of the lower body 12 and the hot contact 34a of the first female socket body 16a. The adapter 10 further comprises a second hot electrical connection 40 between the second hot contact 24 of the lower body 12 and the hot contact 34b of the second female socket body 16b. The adapter 10 further comprises a first neutral electrical connection 44 between the male metal threaded base 14 and either the first female threaded socket 32a or a neutral contact (not illustrated) adjacent the first female threaded socket (such a neutral contact adjacent the first female threaded socket would typically be used if the first female threaded socket is constructed of plastic or some other non-conductive material). (If a neutral contact adjacent the first female threaded socket is used (because, for example, the first female threaded socket is constructed of plastic or some other non-conductive material), then the necessary insulator or insulating gap discussed above would be between the hot contact and the neutral contact adjacent the first female threaded socket.) The adapter 10 further comprises a second neutral electrical connection 46 between the male metal threaded base 14 and either the second female threaded socket 32b or a neutral contact (not illustrated) adjacent the second female threaded socket (such a neutral contact adjacent the second female threaded socket would typically be used if the second female threaded socket is constructed of plastic or some other non-conductive material). (If a neutral contact adjacent the second female threaded socket is used (because, for example, the second female threaded socket is constructed of plastic or some other non-conductive material), then the necessary insulator or insulating gap discussed above would be between the hot contact and the neutral contact adjacent the second female threaded socket.)

The hot contact 34a of the first female socket body 16a is adapted to energize the first one-way light bulb (not illustrated) when the first one-way light bulb is screwed into the first female threaded socket 32a and when the first hot contact 20 of the lower body 12 is energized. The hot contact 34b of the second female socket body 16b is adapted to energize the second one-way light bulb (not illustrated) when the second one-way light bulb is screwed into the second female threaded socket 32b and when the second hot contact 24 of the lower body 12 is energized.

The first and second female socket bodies are positioned and/or angled such that the first and second one-way light bulbs do not contact each other when the first one-way light bulb is screwed into the first female threaded socket and when the second one-way light bulb is screwed into the second female threaded socket.

In the embodiment illustrated in FIGS. 1-3, the first and second female socket bodies project upward from the lower body and outward at an angle to a longitudinal axis of the lower body.

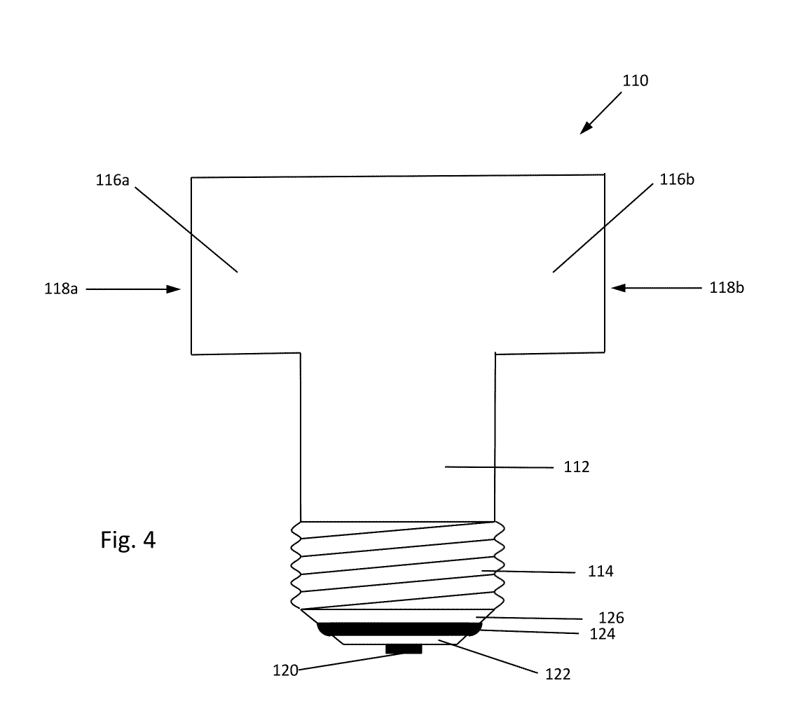

In the embodiment illustrated in FIG. 4, adapter 110 comprises a lower body 112, a first female socket body 116a, and a second female socket body 116b. An opening 118a is defined in the distal end of the first female socket body 116a for receiving a male threaded base of a one-way CFL (not illustrated). An opening 118b is defined in the distal end of the second female socket body 116b for receiving a male threaded base of a one-way CFL (not illustrated). The lower body 112 comprises a male metal threaded base 114 for screwing into a three-way light socket, a first hot contact 120 for contacting a corresponding first hot contact (not illustrated) in the three-way light socket (not illustrated) when the male metal threaded base 114 is screwed into the three-way light socket, and a second hot contact 124 for contacting a corresponding second hot contact (not illustrated) in the three-way light socket (not illustrated) when the male metal threaded base 114 is screwed into the three-way light socket. One or more electrical insulators may be provided for electrically insulating the male metal threaded base, the first hot contact of the lower body, and the second hot contact of the lower body from each other. In the illustrated embodiment, a first electrical insulator 122 electrically insulates the first hot contact 120 and the second hot contact 124 from each other, and a second electrical insulator 126 electrically insulates the second hot contact 124 and the male metal threaded base 114 from each other. As seen in FIG. 4, the first and second female socket bodies 116a, 116b project outward from the lower body 12 perpendicularly to a longitudinal axis of the lower body. The electrical wiring and connections in adapter 110 of FIG. 4 would be the same as that of adapter 10 illustrated in FIG. 3.

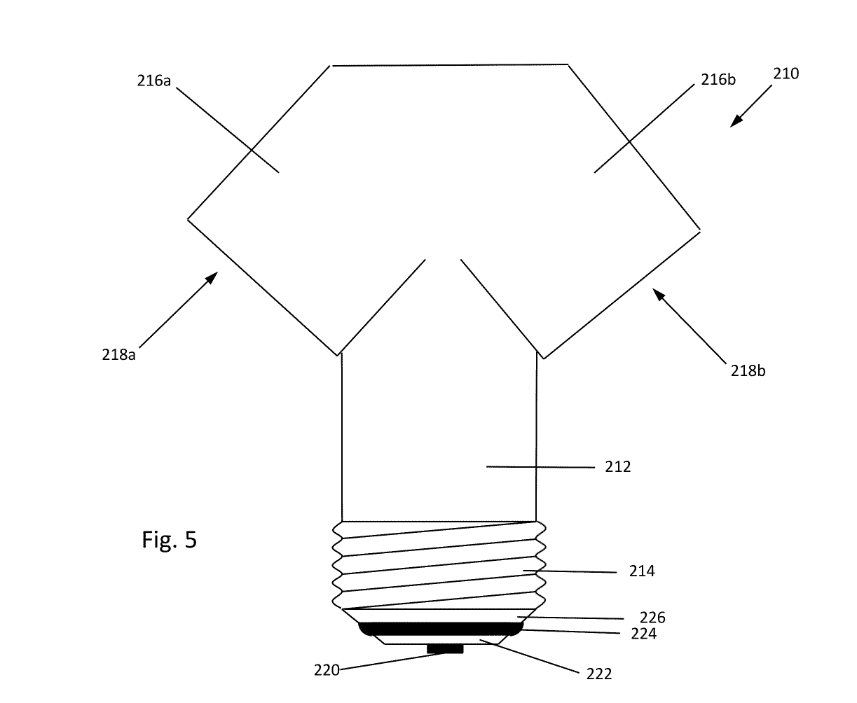

In the embodiment illustrated in FIG. 5, adapter 210 comprises a lower body 212, a first female socket body 216a, and a second female socket body 216b. An opening 218a is defined in the distal end of the first female socket body 216a for receiving a male threaded base of a one-way CFL (not illustrated). An opening 218b is defined in the distal end of the second female socket body 216b for receiving a male threaded base of a one-way CFL (not illustrated). The lower body 212 comprises a male metal threaded base 214 for screwing into a three-way light socket, a first hot contact 220 for contacting a corresponding first hot contact (not illustrated) in the three-way light socket (not illustrated) when the male metal threaded base 214 is screwed into the three-way light socket, and a second hot contact 224 for contacting a corresponding second hot contact (not illustrated) in the three-way light socket (not illustrated) when the male metal threaded base 214 is screwed into the three-way light socket. One or more electrical insulators may be provided for electrically insulating the male metal threaded base, the first hot contact of the lower body, and the second hot contact of the lower body from each other. In the illustrated embodiment, a first electrical insulator 222 electrically insulates the first hot contact 220 and the second hot contact 224 from each other, and a second electrical insulator 226 electrically insulates the second hot contact 224 and the male metal threaded base 214 from each other. As seen in FIG. 5, the first and second female socket bodies 218a, 218b project downward from an upper portion of the lower body and outward at an angle to a longitudinal axis of the lower body. The electrical wiring and connections in adapter 210 of FIG. 5 would be the same as that of adapter 10 illustrated in FIG. 3.

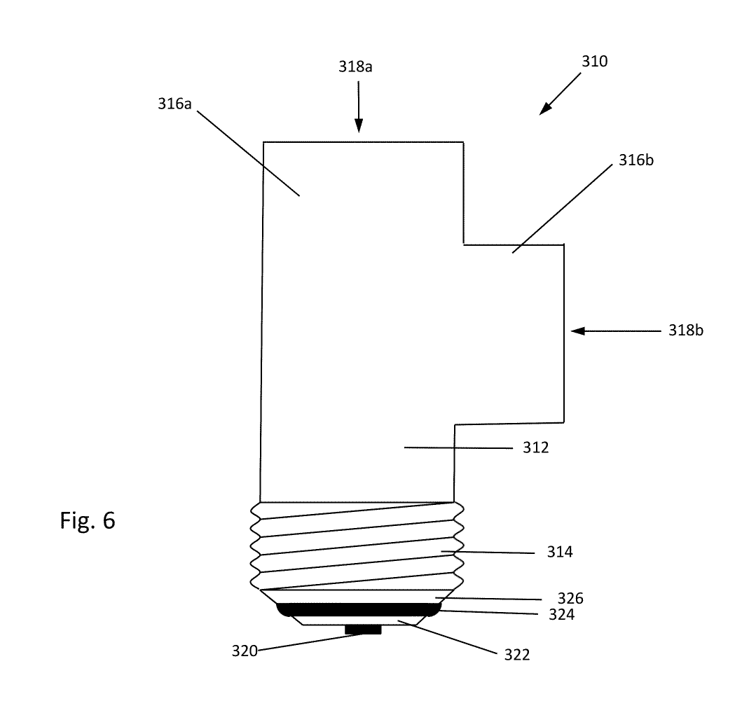

In the embodiment illustrated in FIG. 6, adapter 310 comprises a lower body 312, a first female socket body 316a, and a second female socket body 316b. An opening 318a is defined in the distal end of the first female socket body 316a for receiving a male threaded base of a one-way CFL (not illustrated). An opening 318b is defined in the distal end of the second female socket body 316b for receiving a male threaded base of a one-way CFL (not illustrated). The lower body 312 comprises a male metal threaded base 314 for screwing into a three-way light socket, a first hot contact 320 for contacting a corresponding first hot contact (not illustrated) in the three-way light socket (not illustrated) when the male metal threaded base 314 is screwed into the three-way light socket, and a second hot contact 324 for contacting a corresponding second hot contact (not illustrated) in the three-way light socket (not illustrated) when the male metal threaded base 314 is screwed into the three-way light socket. One or more electrical insulators may be provided for electrically insulating the male metal threaded base, the first hot contact of the lower body, and the second hot contact of the lower body from each other. In the illustrated embodiment, a first electrical insulator 322 electrically insulates the first hot contact 320 and the second hot contact 324 from each other, and a second electrical insulator 326 electrically insulates the second hot contact 324 and the male metal threaded base 314 from each other. As seen in FIG. 6, the first female socket body 316a projects upward from the lower body parallel to a longitudinal axis of the lower body and the second female socket body 316b projects outward from the lower body perpendicularly to the longitudinal axis of the lower body. The electrical wiring and connections in adapter 310 of FIG. 6 would be the same as that of adapter 10 illustrated in FIG. 3.

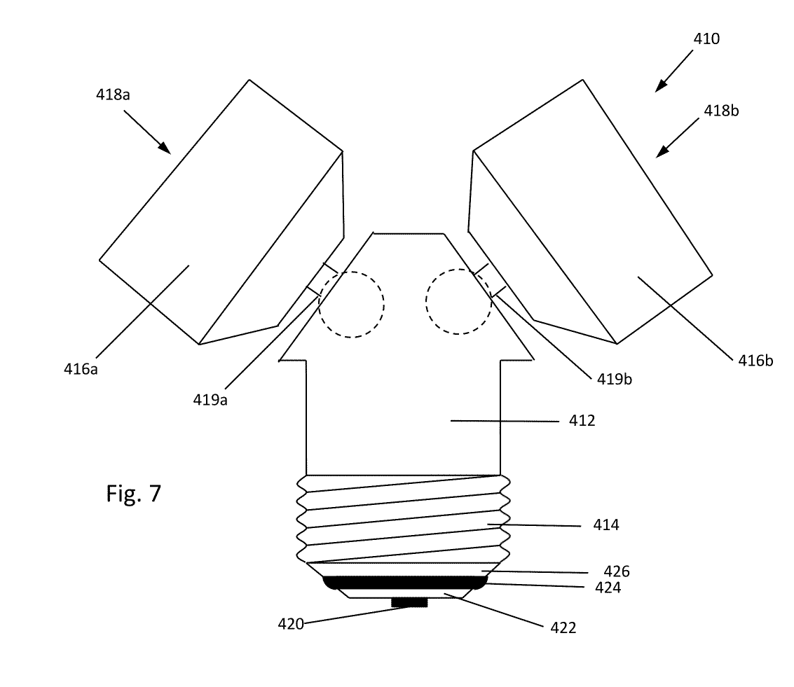

In the embodiment illustrated in FIG. 7, adapter 410 comprises a lower body 412, a first female socket body 416a, and a second female socket body 416b. An opening 418a is defined in the distal end of the first female socket body 416a for receiving a male threaded base of a one-way CFL (not illustrated). An opening 418b is defined in the distal end of the second female socket body 416b for receiving a male threaded base of a one-way CFL (not illustrated). The lower body 412 comprises a male metal threaded base 414 for screwing into a three-way light socket, a first hot contact 420 for contacting a corresponding first hot contact (not illustrated) in the three-way light socket (not illustrated) when the male metal threaded base 414 is screwed into the three-way light socket, and a second hot contact 424 for contacting a corresponding second hot contact (not illustrated) in the three-way light socket (not illustrated) when the male metal threaded base 414 is screwed into the three-way light socket. One or more electrical insulators may be provided for electrically insulating the male metal threaded base, the first hot contact of the lower body, and the second hot contact of the lower body from each other. In the illustrated embodiment, a first electrical insulator 422 electrically insulates the first hot contact 420 and the second hot contact 424 from each other, and a second electrical insulator 426 electrically insulates the second hot contact 424 and the male metal threaded base 414 from each other. As seen in FIG. 7, the first female socket body 416a is movably connected to the lower body 412 via a first ball-and-socket connection 419a, and the second female socket body 416b is movably connected to the lower body 412 via a second ball-and-socket connection 419b. The ball-and-socket connections 419a, 419b enable independent, variable positioning of each one-way CFL, which may be desirable to enable the adapter and CFLs to fit within many different sized and shaped lampshades. The arms (not labeled) of the first and second ball-and-socket connections may be any suitable length. The electrical wiring and connections in adapter 410 of FIG. 7 would be the same as that of adapter 10 illustrated in FIG. 3.

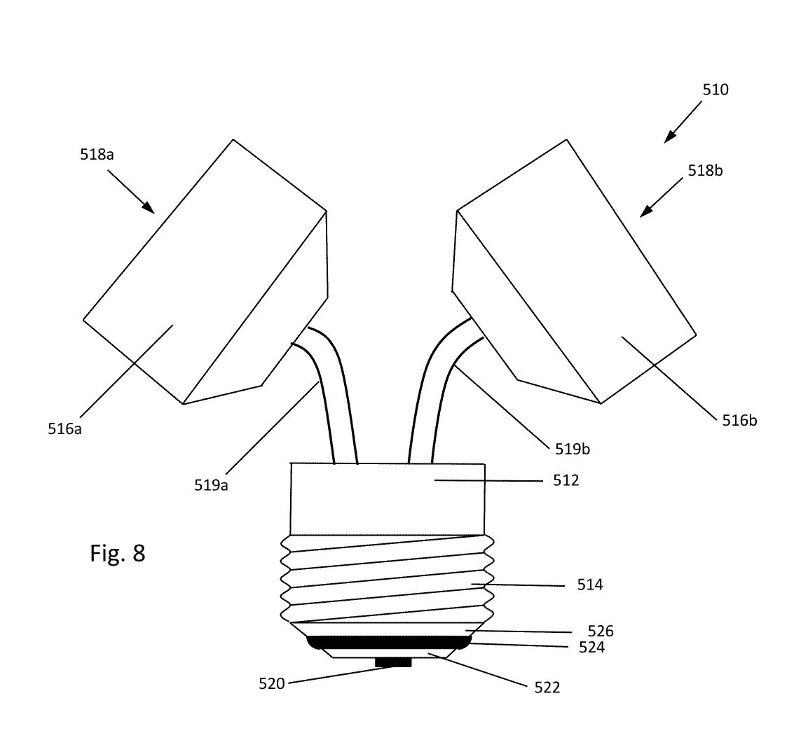

In the embodiment illustrated in FIG. 8, adapter 510 comprises a lower body 512, a first female socket body 516a, and a second female socket body 516b. An opening 518a is defined in the distal end of the first female socket body 516a for receiving a male threaded base of a one-way CFL (not illustrated). An opening 518b is defined in the distal end of the second female socket body 516b for receiving a male threaded base of a one-way CFL (not illustrated). The lower body 512 comprises a male metal threaded base 514 for screwing into a three-way light socket, a first hot contact 520 for contacting a corresponding first hot contact (not illustrated) in the three-way light socket (not illustrated) when the male metal threaded base 514 is screwed into the three-way light socket, and a second hot contact 524 for contacting a corresponding second hot contact (not illustrated) in the three-way light socket (not illustrated) when the male metal threaded base 514 is screwed into the three-way light socket. One or more electrical insulators may be provided for electrically insulating the male metal threaded base, the first hot contact of the lower body, and the second hot contact of the lower body from each other. In the illustrated embodiment, a first electrical insulator 522 electrically insulates the first hot contact 520 and the second hot contact 524 from each other, and a second electrical insulator 526 electrically insulates the second hot contact 524 and the male metal threaded base 514 from each other. As seen in FIG. 7, the first female socket body 516a is movably connected to the lower body 512 via a first flexible arm 519a, and the second female socket body 516b is movably connected to the lower body 512 via a second flexible arm 519b. The flexible arms 519a, 519b enable independent, variable positioning of each one-way CFL, which may be desirable to enable the adapter and CFLs to fit within many different sized and shaped lampshades. The flexible arms 519a, 519b may be any suitable length. The electrical wiring and connections in adapter 510 of FIG. 7 would be the same as that of adapter 10 illustrated in FIG. 3.

In an alternative embodiment that is not illustrated, the first and second female socket bodies may be connected to the lower body via, respectively, first and second flexible arms. Such flexible arms would enable the first and second female socket bodies to be independently positioned in many different positions which may be desirable, for example, to enable the first and second one-way light bulbs to fit within many different sized and shaped lampshades.

In an alternative embodiment that is not illustrated, the first and second female socket bodies may be connected to the lower body via a single flexible arm. Such a flexible arm would enable the first and second female socket bodies to be jointly positioned in many different positions which may be desirable, for example, to enable the first and second one-way light bulbs to fit within many different sized and shaped lampshades.

In an alternative embodiment that is not illustrated, the first and second female socket bodies may be connected to the lower body via, respectively, first and second ball-and-socket joints. Such ball-and-socket joints would enable the first and second female socket bodies to be independently positioned in many different positions which may be desirable, for example, to enable the first and second one-way light bulbs to fit within many different sized and shaped lampshades.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

That which is claimed:

1. An adapter for using two one-way light bulbs in a three-way light socket, the adapter comprising:
a lower body comprising (a) a male metal threaded base for screwing into a three-way light socket, (b) a first hot contact for contacting a corresponding first hot contact in the three-way light socket when the male metal threaded base is screwed into the three-way light socket, and (c) a second hot contact for contacting a corresponding second hot contact in the three-way light socket when the male metal threaded base is screwed into the three-way light socket, the male metal threaded base, the first hot contact of the lower body, and the second hot contact of the lower body being electrically insulated from each other;
a first female socket body connected to the lower body and comprising (a) a first female threaded socket for receiving a first one-way light bulb, and (b) a hot contact for contacting a corresponding hot contact in the first one-way light bulb when the first one-way light bulb is screwed into the first female threaded socket, the first female threaded socket and the hot contact of first female socket body being electrically insulated from each other;
a second female socket body connected to the lower body and comprising (a) a second female threaded socket for receiving a second one-way light bulb, and (b) a hot contact for contacting a corresponding hot contact in the second one-way light bulb when the second one-way light bulb is screwed into the second female threaded socket, the second female threaded socket and the hot contact of second female socket body being electrically insulated from each other;
a first hot electrical connection between the first hot contact of the lower body and the hot contact of the first female socket body;
a second hot electrical connection between the second hot contact of the lower body and the hot contact of the second female socket body;
a first neutral electrical connection between the male metal threaded base and either the first female threaded socket or a neutral contact adjacent the first female threaded socket; and
a second neutral electrical connection between the male metal threaded base and either the second female threaded socket or a neutral contact adjacent the second female threaded socket;
wherein the hot contact of the first female socket body is adapted to energize the first one-way light bulb when the first one-way light bulb is screwed into the first female threaded socket and when the first hot contact of the lower body is energized;
wherein the hot contact of the second female socket body is adapted to energize the second one-way light bulb when the second one-way light bulb is screwed into the second female threaded socket and when the second hot contact of the lower body is energized; and
wherein the first and second female socket bodies are positioned and/or angled such that the first and second one-way light bulbs do not contact each other when the first one-way light bulb is screwed into the first female threaded socket and when the second one-way light bulb is screwed into the second female threaded socket;

2. The adapter of claim 1, wherein the first and second female socket bodies project upward from the lower body and outward at an angle to a longitudinal axis of the lower body.

3. The adapter of claim 1, wherein the first and second female socket bodies project outward from the lower body perpendicularly to a longitudinal axis of the lower body.

4. The adapter of claim 1, wherein the first female socket body projects upward from the lower body parallel to a longitudinal axis of the lower body and the second female socket body projects outward from the lower body perpendicularly to the longitudinal axis of the lower body.

5. The adapter of claim 1, wherein the first and second female socket bodies project downward from an upper portion of the lower body and outward at an angle to a longitudinal axis of the lower body.

6. The adapter of claim 1, wherein the first and second female socket bodies are connected to the lower body via, respectively, first and second flexible arms.

7. The adapter of claim 1, wherein the first and second female socket bodies are connected to the lower body via, respectively, first and second ball-and-socket joints.
